(19) United States
(12) Patent Application Publication
(10) Pub. No.: US 2005/0044285 A1
(43) Pub. Date: Feb. 24, 2005

(54) Data output apparatus

(75) Inventors: Daisuke Sakiyama, Maizuru-shi (JP); Nobuo Kamei, Amagasaki-shi (JP); Masaya Hashimoto, Amagasaki-shi (JP); Takeshi Morikawa, Takarazuka-shi (JP)

Correspondence Address: BURNS DOANE SWECKER & MATHIS L L P, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 10/775,080

(22) Filed: Feb. 11, 2004

(30) Foreign Application Priority Data
Aug. 18, 2003 (JP) 2003-294573

(51) Int. Cl. G06F 3/00

(52) U.S. Cl. 710/15

(57) ABSTRACT

In addition to a data processing memory that processes data for an input print job, the present invention includes a mounting unit that enables mounting of an expansion memory used for data storage, as well as a detection unit that detects whether or not an expansion memory is mounted to the mounting unit. Where the job is one in which the data therefor is to be output multiple times, the controller selects the storage destination memory for the data used for output of the second copy onward in accordance with whether or not an expansion memory is mounted, and stores the data in the selected storage destination memory. The output unit reads out the data from the selected storage destination memory and performs output of the second copy onward.

The present application claims priority to Japanese Patent Application No. 2003-294573 filed Aug. 18, 2003, the entire content of which is hereby incorporated by reference.

### BACKGROUND OF THE INVENTION

1. Field of the Invention

The present invention relates to a data output apparatus such as a printer.

2. Description of the Related Art

When a data output apparatus such as a printer receives a print job sent from an external device such as a personal computer, the print data for the job that is expressed in Page Description Language (PDL) undergoes RIP (Raster Image Processor) processing in the data processing memory and is converted to image data, and this image data is output onto paper by a printer unit.

Where multiple copies of the data are printed using this type of printer, there are various methods employed in the conventional art for processing the data.

For example, in a printer that includes a data storage memory separate from the data processing memory, the image data generated in the data processing memory is stored once in this storage memory, and the second and subsequent copies of this data may be printed by reading out the data from the storage memory.

Where two or more copies are to be printed and no storage memory is present, the data for all copies after the first printing is resent from the external device.

A printer has also been proposed wherein, where all of the data cannot be stored in a memory and multiple copies are to be printed, multiple copies of the received data are first printed, and sending of the remaining data from the external device is put on hold (See Japanese Laid-Open Patent Application 2000-301780).

In addition, a printer has also been proposed wherein, where all of the data cannot be stored in the data storage memory, the remaining data is stored in the data processing memory, the data for the first printing is read out from the data processing memory and printed, and subsequent copies are printed by reading out the data stored in the data storage memory and resending the rest of the data from the external device for printing (See Japanese Laid-Open Patent Application 2000-259367).

A printer has also been proposed wherein, where multiple copies are to be printed and it takes longer to create a display list than to print a one-page copy, the display list is stored in a memory and all copies after the first printing are read out from the memory and printed, while if it takes less time to create the display list, the data for that task is sent each time from the external terminal device (See Japanese Laid-Open Patent Application 2000-322210).

Incidentally, some printers allow an administrator to retrofit the data storage memory described above therein as an expansion memory in accordance with the state of usage thereof.

However, in the conventional printers described above, the presence or absence of the data storage memory is fixed beforehand, and the processing of the data where multiple copies are to be printed is fixed accordingly, such that the processing of data cannot be changed in accordance with whether or not an expansion memory for data storage has been mounted.

In addition, where the data for printing is resent from the external device for each printing of the second and subsequent copies, the problem arises that the amount of data traffic on the network increases significantly.

### SUMMARY OF THE INVENTION

A principal object of the present invention is to provide a data output apparatus that, where multiple copies of data are to be printed, permits the processing of data to be changed in accordance with whether not an expansion memory for data storage has been mounted.

Another object of the present invention is to provide a data output apparatus that does not require resending of data even where an expansion memory has not been mounted therein.

In order to achieve these and other objects, the data output apparatus according to one aspect of the present invention includes the following:
a processing memory that processes input job data;
an output unit that, after processing of data sent to the processing memory, outputs this data;
a mounting unit for mounting of the expansion memory used for data storage;
a detection unit that detects whether or not an expansion memory has been mounted to the mounting unit; and
a controller that, where the job is a job in which the identical data is to be output multiple times, (i) selects, based on the results of the detection by the detection unit, the storage destination memory for the data for the second output session and beyond and stores the data therein, and (ii) reads out the data from this storage destination memory and causes the output unit to perform output for the second output session onward.

In this data output apparatus, the detection unit detects whether or not an expansion memory is mounted to the mounting unit used for the mounting of an expansion memory for data storage. Where the job is a job in which the identical data is to be output multiple times, the controller (i) selects, based on the results of the detection by the detection unit, the storage destination memory for the data for the second output session and beyond and stores the data therein, and (ii) reads out the data from this storage destination memory and causes the output unit to perform output for the second output session onward.

In other words, because the data used for output from the second output session onward is stored in the optimal storage destination memory based on the results of the detection by the detection unit and is output from such optimal storage destination memory, superior performance where the data is to be output multiple times is achieved regardless of whether or not an expansion memory has been mounted. Furthermore, because the data for the second output session onward is stored in a memory located inside the data output apparatus even where an expansion memory has not been mounted, such data need not be resent.

This data output apparatus may alternatively have a construction wherein, if the mounting of an expansion memory is detected by the expansion memory detection unit, the controller stores the data for the second output session onward in such expansion memory, while if the mounting of an expansion memory is not detected by the expansion memory detection unit, the controller stores the data for the second output session onward in the processing memory.

In this case, because if an expansion memory is mounted, the data for the second output session onward is stored in such expansion memory, while if an expansion memory is not mounted, the data for the second output session onward is stored in the processing memory, the data is stored in the optimal memory.

In such a case, the data output apparatus may have a construction wherein the controller causes the data processed in the processing memory to be output therefrom for the first output session if the mounting of an expansion memory is detected by the detection unit.

In this way, the data for the first output session need not be stored in and read out from the expansion memory, which reduces the amount of time needed for data output.

Furthermore, the data output apparatus may have a construction wherein the controller determines the storage format for the data used for the second output session onward in accordance with the results of the detection by the detection unit.

In such a case, the data used for the second output session onward is stored in the optimal storage format.

Specifically, if the job is a print job sent from an external device and the mounting of an expansion memory is detected by the detection unit, the controller stores the input data in the expansion memory in the format of the image data resulting from processing in the processing memory, while if the mounting of an expansion memory is not detected, the controller stores the input data in the processing memory in the data's format prior to its processing in the processing memory.

Because the data is stored in the processing memory in the data's format prior to its processing therein, the data size can be made smaller than if the post-processing data were stored.

Furthermore, the data output apparatus may include a compression/decompression unit that compresses the data to be stored in the expansion memory and decompresses the compressed data.

In such a case, because the data is stored in the expansion memory after it is compressed by the compression/decompression unit, the data size can be reduced, allowing more data to be stored in the expansion memory.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the construction of a data output apparatus pertaining to an embodiment of the present invention;

FIG. 2 is a flow chart showing the sequence of the routine executed by the CPU when a print job is printed by the data output apparatus shown in FIG. 1;

FIG. 3 is a drawing showing the flow of data in the data processing memory and the state of use of the work memory in the case where an expansion memory has not been mounted and the case where an expansion memory has been mounted; and

FIG. 4 is a flow chart showing the receiving routine executed by the CPU when a scan job request has been issued while a print job sent from an external device is being printed.

In the following description, like parts are designated by like reference numbers throughout the several drawings.

### DETAILED DESCRIPTION OF THE PREFERRED EMBODIMENTS

An embodiment of the present invention will now be described.

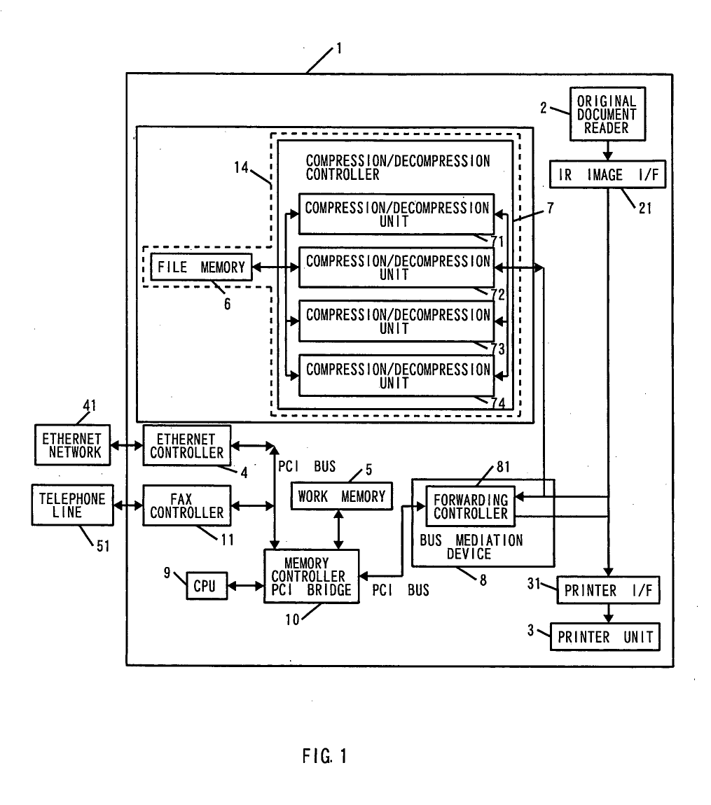

FIG. 1 is a block diagram of the data output apparatus 1 pertaining to an embodiment of the invention. In this embodiment, a multi-function peripheral (MFP) having multiple functions such as a copier function, a printer function, a scanner function and a facsimile (hereinafter ‘fax’) function is used as the data output apparatus.

This data output apparatus includes an original document reader 2, a printer unit 3 that serves as output means, an Ethernet controller 4 and a fax controller 11.

The original document reader 2 includes a scanner that reads original documents, and the image data for the read original document is sent to a bus mediation device 8 via a read image interface (termed an ‘IR image I/F’ in the drawing) 21.

The printer unit 3 prints the image data forwarded from the bus mediation device 8 onto paper or other medium.

The Ethernet controller 4 sends and receives jobs over an Ethernet network] 4. It receives over the Ethernet network 41 print jobs or Internet fax jobs sent by an external device such as a personal computer or an Internet fax machine (not shown in the drawing), or sends to an external device via the Ethernet network 41 image data for an original document read by the original document reader 2.

The fax controller 11 sends and receives fax jobs to and from external fax machines (not shown in the drawing) over a telephone line 51. It receives a fax job sent by an external fax machine via the telephone line 51, or sends to an external fax machine over the telephone line 51 the image data for an original document read by the original document reader 2.

The MFP 1 also includes a work memory 5, an expansion memory unit mounting unit 12, an expansion memory detection unit 13, the bus mediation device 8, a CPU 9 and a memory controller-PCI bridge 10.

The work memory 5 is a data processing memory in which data to be output is processed or in which other data is stored. Such output data may constitute print data included in a print job sent from an external device and received by the Ethernet controller 4, data included in a fax job received by the fax controller 11, or image data read by the original document reader 2.

The expansion memory unit mounting unit 12 enables an expansion memory unit 14 to be detachably mounted, and FIG. 1 shows the case in which the expansion memory unit 14 is mounted.

The expansion memory unit 14 incorporates as a single unit a file memory 6 that functions as an expansion memory (the file memory 6 will also be referred to as an ‘expansion memory’ below) and a compression/decompression controller 7. The file memory 6 and compression/decompression controller 7 need not have an integral construction, and may be mounted separately.

The compression/decompression controller 7 includes four compression/decompression units 71-74 that are connected in series in this embodiment, and causes the compression/decompression units 71-74 to handle the tasks of compressing and decompressing the data forwarded from the work memory 5.

The file memory 6 cumulatively stores the data compressed by the compression/decompression units 71-74.

The expansion memory detection unit 13 detects whether or not a file memory 6 has been mounted to the expansion memory unit mounting unit 12.

The bus mediation device 8 forwards to the various components of the MFP 1 via a forwarding controller 81 the data to be output.

The memory controller-PCI bridge 10 controls the work memory 5 and connects the CPU 9 bus and the PCI bus.

In addition to carrying out comprehensive control of the MFP 1, i.e., control of the memory controller-PCI bridge 10, the forwarding controller 81, the compression/decompression controller 7, the expansion memory unit 14 and the expansion memory unit detection unit 13, the CPU 9 makes various determinations. For example, it determines based on the results of the detection by the expansion memory detection unit 13 whether or not a file memory 6 is mounted, whether or not the input job involves printing of multiple copies, and whether, where the job is for printing of multiple copies, printing of the first copy or of subsequent copies is to be carried out.

The types of jobs that can be executed by the MFP 1 shown in FIG. 1 are copy jobs, scan jobs, fax transmission jobs, fax receipt jobs and print jobs. The flow of data for each of these types of jobs is summarized below.

For copy jobs, the image data read by the original document reader 2 is forwarded to the printer unit 3 via the read image interface 21, the work memory 5 and the printer interface 31, whereupon it is printed.

For scan jobs, the image data read by the original document reader 2 is sent to an external device via the read image interface 21, the work memory 5, the Ethernet controller 4 and the Ethernet network 41.

For fax transmission jobs, the image data read by the original document reader 2 is sent to an external fax machine via the read image interface 21, the work memory 5, the fax controller 11 and the telephone circuit 51.

For fax receipt jobs, the image data sent from an external fax machine via the telephone circuit 51 is forwarded to the printer unit 3 via the fax controller 11, the work memory 5 and the printer interface 31, whereupon it is printed.

For print jobs, the print data sent from an external device via the Ethernet network 41 is forwarded to the printer unit 3 via the Ethernet controller 4, the work memory 5 and the printer interface 31, and is then printed. The data flow for this type of print job is described in more detail below.

[Where a File Memory 6 is Mounted]

The print data sent from an external device via the Ethernet [network] 41 and expressed in Page Description Language (PDL) or intermediate code is received by the Ethernet controller 4 and undergoes RIP processing in the work memory 5. The image data that has undergone RIP processing is forwarded to the printer unit 3 via the memory controller-PCI bridge 10, the PCI bus, the bus mediation device 8 and the printer interface 31, whereupon the first print session is carried out.

The image data that underwent RIP processing in the work memory 5 is forwarded to the compression/decompression controller 7 at the same time it is forwarded to the printer unit 3, whereupon it is compressed by the compression/decompression units 71-74 and stored in the file memory 6.

Because the received data is no longer needed at the moment all processing is completed, the received data is flushed. When the compressed image data is stored in the file memory 6, the data processed in the work memory 5 is no longer needed, and it is therefore flushed.

For printing of the second copy onward, the compressed data stored in the file memory 6 is decompressed in the work memory 5 by the compression/decompression units 71-74 of the compression/decompression controller 7, the resulting decompressed image data is forwarded to the printer unit 3 via the memory controller-PCI bridge 10, the PCI bus, the bus mediation device 8, and the printer interface 31, and the data is then printed.

[Where an Expanded Memory is not Mounted]

The print data sent from an external device via the Ethernet network 41 and expressed in Page Description Language (PDL) or intermediate code is received by the Ethernet controller 4 and undergoes RIP processing in the work memory 5. The image data that has undergone RIP processing is forwarded to the printer unit 3 via the memory controller-PCI bridge 10, the PCI bus, the bus mediation device 8 and the printer interface 31, whereupon the first print session is carried out.

Where more than one copy must be printed, the pre-RIP processing received data is left in the work memory 5, but when only one copy is printed, the received data is flushed when all processing is completed. In addition, processed data is flushed when it has been printed.

For printing of the second copy onward, the received data stored in the work memory 5 undergoes RIP processing each time a print session is carried out. The re-processed image data is forwarded to the printer unit 3 via the memory controller-PCI bridge 10, the PCI bus, the bus mediation device 8 and the printer interface 31, whereupon it is printed. The processed data is flushed after it is printed. After completion of the final print session, the received data is also flushed.

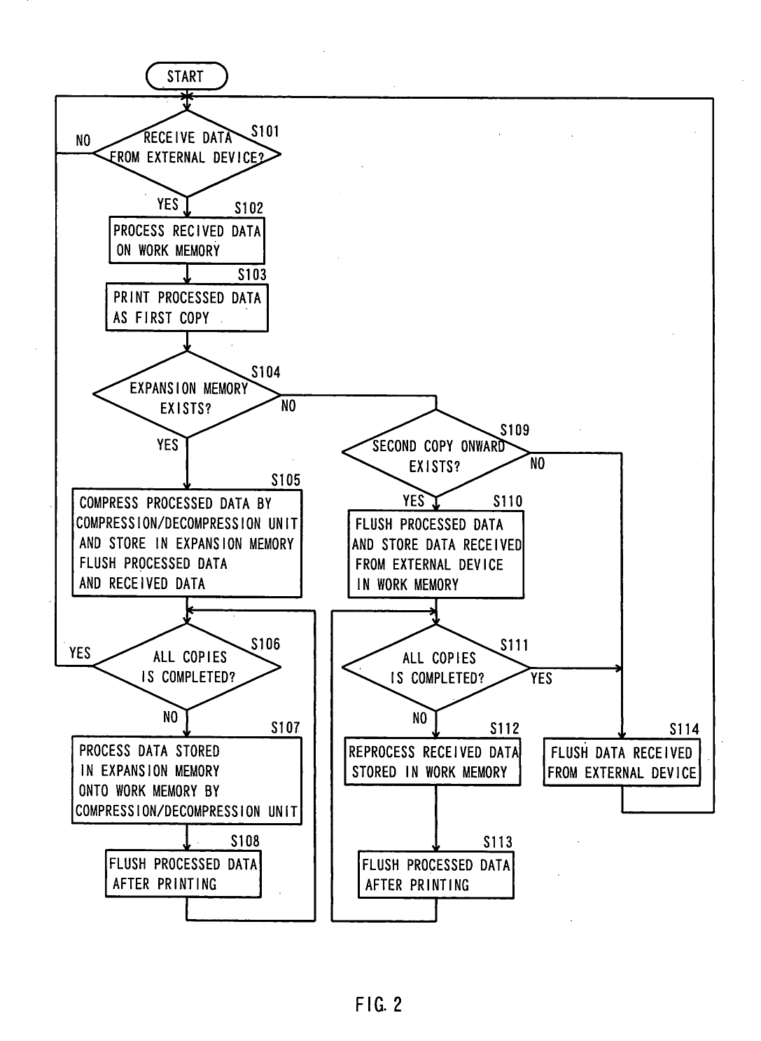

The routine executed by CPU9 when the above print job is printed is shown in the flow chart of FIG. 2. In the chart and in the description below, the word ‘Step’ is represented by the letter ‘S’.

First, in S101, the CPU 9 determines whether or not data (a job) has been received from an external device. If data has not been received (the determination in S101 is NO), the CPU 9 waits at S101. If data has been received (the determination in S101 is YES), the CPU 9 subjects the received data to RIP processing in the work memory 5 in S102, and then forwards the processed data to the printer unit 3 via the above-described path and executes the first print session in S103.

The CPU 9 then determines in S104, based on a signal from the expansion memory detection unit 13, whether or not a file memory (expansion memory) 6 is present. If a file memory 6 is present (the determination in S104 is YES), the processed data is compressed by the compression/decompression units 71-74, and is stored in the file memory 6 in S105, and the processed data and received data residing in the work memory 5 are flushed.

The CPU 9 then determines in S106 whether or not printing of all copies has been completed. If printing of all copies has been completed (the determination in S106 is YES), the CPU 9 returns to S101. If printing of all copies has not been completed (the determination in S106 is NO), the data stored in the file memory 6 is processed in the work memory 5 by the compression/decompression units 71/74 in S107. In S108, after the processed data has been forwarded to the printer unit 3, the data is flushed, the CPU 9 returns to S106, and the processes of steps S106-S 108 are repeated until printing of all copies is completed.

On the other hand, if it is determined in S104 that a file memory (expansion memory 6) is not present (the determination in S104 is NO), it is determined in S109 whether or not a print instruction for the second copy onward has been issued. If a print instruction for the second copy onward has not been issued (the determination in S109 is NO), after the data received from the external device is flushed in S114, the CPU 9 returns to S101.

If a print instruction for the second copy onward has been issued (the determination in S109 is YES), the data processed in the work memory 5 in S110 is flushed, and the data received from the external device is stored in the work memory 5.

It is then determined in S111 whether or not printing of all copies has been completed. If printing of all copies has been completed (the determination in S111 is YES), the CPU 9 returns to S114, flushes the received data, and returns to S101. If the printing of all copies has not been completed (the determination in S111 is NO), the received data stored in the work memory 5 undergoes RIP processing once more in S12. After the processed data is forwarded to the printer unit 3 in S113, the data is flushed, the CPU 9 returns to S111, and the processes of steps S111-S113 are repeated until printing of all copies is completed.

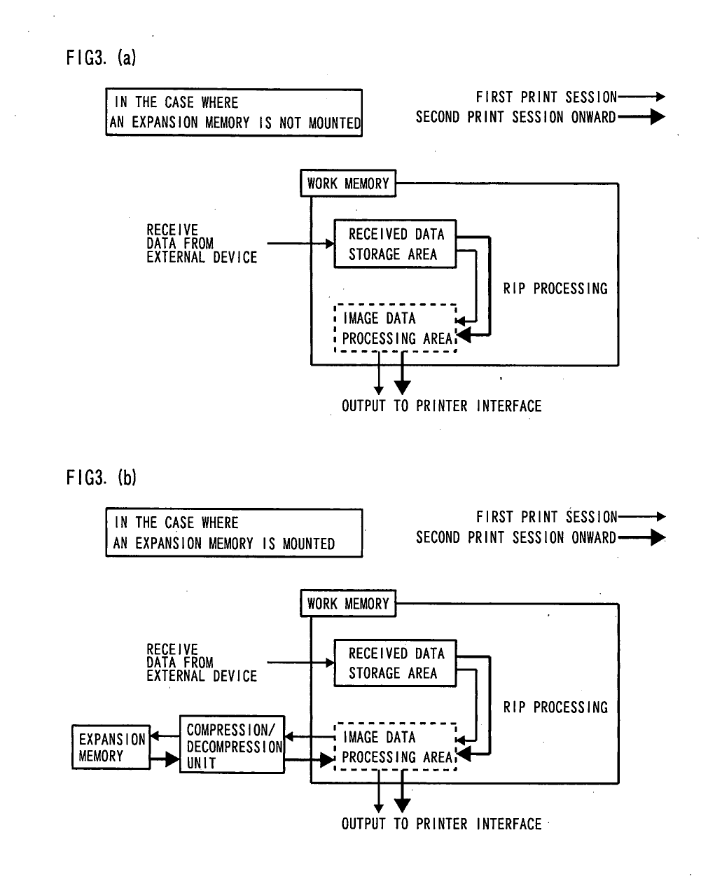

FIG. 3 shows the flow of data in the work memory 5 and the state of use of the work memory 5 in the case where a file memory 6 has not been mounted and the case where a file memory 6 has been mounted. In FIG. 3, the fine arrow indicates the flow of data for the first print session, and the thick arrow indicates the flow of data for the second print session onward.

In the case where an expansion memory is not mounted, as shown in FIG. 3(a), the received data is stored in the received data storage area of the work memory 5, and undergoes RIP processing in the image data processing area. The RIP-processed image data is then forwarded to the printer unit 3 and flushed.

For the second print session onward, the received data stored in the received data storage area is processed once more in the image data processing area and forwarded to the printer unit 3.

In the case where an expansion memory is mounted, as shown in FIG. 3(b), the received data is stored in the received data storage area in the work memory 5, and undergoes RIP processing in the image data processing area. The received data is then flushed after it is processed. The processed image data is forwarded to the printer unit 3, compressed by the compression/decompression units 71-74 and stored in the file memory 6.

For the second print session onward, the image data stored in the file memory 6 is decompressed in the image data processing area by the compression/decompression units 71-74. The decompressed image data is forwarded to the printer unit 3.

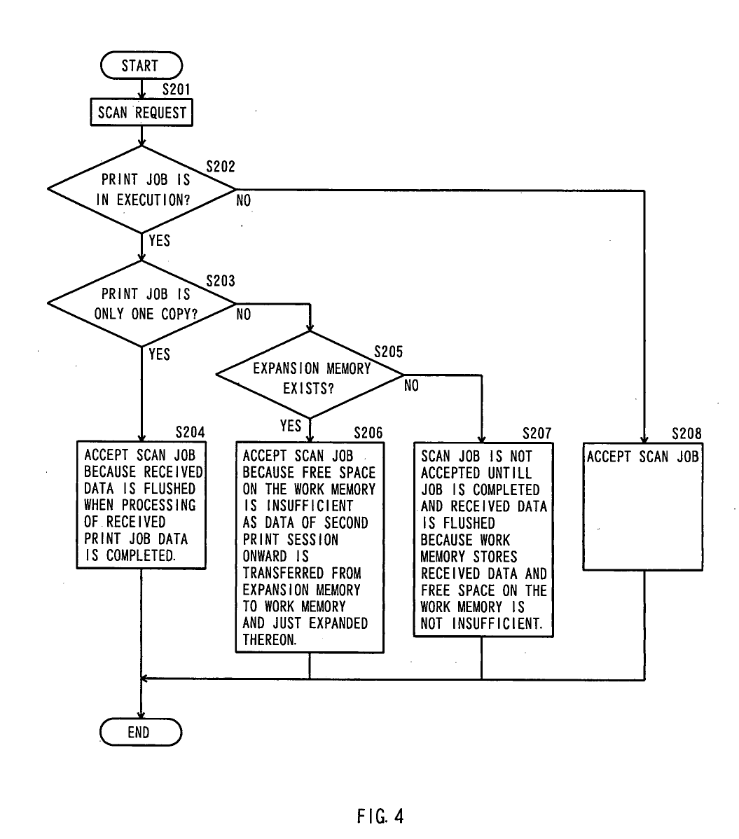

FIG. 4 is a flow chart showing the receiving routine executed by the CPU 9 when a request for a scan job as described above has been issued while a print job is being printed.

In FIG. 4, when a scan request is received in S201, the CPU 9 determines in S202 whether a print job is being printed. If a print job is not being printed (the determination in S202 is NO), the scan job is accepted in S208.

If a print job is being printed (the determination in S202 is YES), it is determined in S203 whether or not only one copy of the print job is to be printed. If so (the determination in S203 is YES), because the work memory can be cleared by flushing the received data at the moment that the processing of the received print job data is completed, the scan job is accepted at the moment that the work memory is cleared in S204.

If it is determined in S203 that more than one copy is to be printed (the determination in S203 is NO), it is determined in S205 whether or not a file memory 6 is mounted. If a file memory 6 is mounted (the determination in S205 is YES), because the received data is flushed at the moment that processing thereof is completed, the scan job is accepted at that moment in S206.

If a file memory 6 is not mounted (the determination in S205 is NO), because the received data is stored in the work memory 5 until the print job is completed, the scan job is not accepted until the print job is completed and the received data is flushed in S207.

The routine shown in FIG. 4 can also be applied not only to scan jobs, but also to the receipt of fax transmission jobs.

While an embodiment of the present invention was described above, the present invention is not limited to the above embodiment.

For example, a case was described in which an expansion memory (file memory) 6 was mounted to the expansion memory mounting unit 12 together with the compression/decompression controller 7, but it is acceptable if only the expansion memory 6 is mounted, without the compression/decompression controller 7. In this case, the data is stored in the expansion memory 6 without being compressed, and the read-out data is handled as is without being decompressed. However, using a compression/decompression controller 7 to compress and decompress the data enables the stored data to be made smaller in size, thereby permitting storage of a larger amount of data.

Furthermore, in the above embodiment, where an expansion memory 6 is not mounted, the received data is stored in the work memory 5 for use in carrying out printing of the second print session onward of a print job, but it is acceptable if the image data resulting from RIP processing, rather than the received data, is stored in the work memory 5. However, storage of the received data is preferred because the data size of the stored data is smaller.

In addition, a case was described above wherein the data storage destination memory for a print job is changed depending on the presence or absence of an expansion memory 6, but the same sort of control may be performed for a copy job or other type of job, for example.

Specifically, where an expansion memory 6 is not mounted, the original document image data read by the original document reader 2 and forwarded to the work memory 5 is stored in the work memory 5, and for the second print session onward, the image data stored in the work memory 5 is read out therefrom and printed. On the other hand, where an expansion memory 6 is mounted, a construction may be adopted wherein the original document image data read by the original document reader 2 is forwarded to the expansion memory 6 from the work memory 5 and stored therein at the same time that it is forwarded to the printer unit 3, and printing for the second copy onward is executed by calling out the data from the expansion memory 6.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

1. A data output apparatus, comprising:
a processing memory that processes input job data;
an output unit that, after processing of data sent to said processing memory, outputs said data;
a mounting unit for mounting of the expansion memory used for data storage;
a detection unit that detects whether or not an expansion memory has been mounted to said mounting unit; and
a controller that, where said job is a job in which the identical data is to be output multiple times, (i) selects, based on the results of the detection by said detection unit, the storage destination memory for the data for the second output session and beyond and stores the data therein, and (ii) reads out said data from this storage destination memory and performs output for the second output session onward using the output unit.

2. The data output apparatus according to claim 1, wherein if it is detected by said detection unit that an expansion memory is mounted, said controller stores the data used for said second output session onward in said expansion memory, while if it is not detected by said detection unit that an expansion memory is mounted, said controller stores the data used for said second output session onward in said processing memory.

3. The data output apparatus according to claim 2, wherein if it is detected by said detection unit that an expansion memory is mounted, said controller outputs the data processed in said processing memory as is for the first output session.

4. The data output apparatus according to claim 1, wherein said controller determines the storage format for the data used for the second output session onward in accordance with the results of the detection by said detection unit.

5. The data output apparatus according to claim 4, wherein where the job is a print job sent from an external device, if the mounting of an expansion memory is detected by said detection unit, said controller stores the input data in said expansion memory in the format of the image data resulting from processing in said processing memory, while if the mounting of an expansion memory is not detected by the detection unit, said controller stores the input data in said processing memory in the data's format prior to its processing in said processing memory.

6. The data output apparatus according to claim 1, further comprising one or more compression/decompression unit(s) that compress data and decompress compressed data.

7. The data output apparatus according to claim 6, wherein said expansion memory stores data compressed by said compression/decompression unit(s).

8. A printer, comprising:
a receiving unit that receives print jobs;
a processing memory that processes image data for print jobs received by said receiving unit;
a printer unit that prints image data after it has been processed in said processing memory;
a mounting unit used for mounting of an expansion memory for data storage;
a detection unit that detects whether or not an expansion memory is mounted to said mounting unit; and
a controller that, where the job is a job in which multiple copies of identical images are to be printed, (i) selects the storage destination memory for the image data for the second output session and beyond based on the results of the detection by said detection unit, and stores the image data therein, and (ii) reads out said image data from this storage destination memory and executes printing for the second copy onward via said printer unit.

9. The printer according to claim 8, wherein if it is detected by said detection unit that an expansion memory is mounted, said controller stores the image data used for printing of the second copy onward in said expansion memory, while if it is not detected by said detection unit that an expansion memory is mounted, said controller stores the image data used for printing of the second copy onward in said processing memory.

10. The printer according to claim 9, wherein if it is detected by said detection unit that an expansion memory is mounted, said controller prints out the first copy using the image data processed in said processing memory.

11. The printer according to claim 8, wherein said controller determines the storage format for the image data used for the second copy onward in accordance with the results of the detection by said detection unit.

12. The printer according to claim 8, further comprising one or more compression/decompression unit(s) that compress image data and decompress compressed data.

13. The printer according to claim 12, wherein said expansion memory stores data compressed by said compression/decompression unit(s).

14. A printer comprising:
a receiving unit that receives print jobs;
a work memory that includes a storage area used for storing image data for print jobs received by said receiving unit, as well as a processing area used for converting image data to raster images;
a printer unit that prints image data after it has been processed in said processing area;
a mounting unit used for mounting of an expansion memory for data storage;
a detection unit that detects whether or not an expansion memory is mounted to said mounting unit; and
a controller that, where the job is a job in which multiple copies of identical images are to be printed, (i) if it is detected by said detection unit that an expansion memory is mounted, stores the image data stored in said work memory in said expansion memory and executes printing for the second copy onward via the printer unit using the image data stored in said expansion memory, and (ii) if it is not detected that an expansion memory is mounted, executes printing for the second copy onward via the printer unit using the image data stored in said work memory.

15. The printer according to claim 14, further comprising one or more compression/decompression unit(s) that compress image data input from said processing area, decompress compressed image data and output decompressed image data to said processing area.

16. The printer according to claim 15, wherein said expansion memory stores image data compressed by said compression/decompression unit(s).
